(19) United States
(12) Patent Application Publication
(10) Pub. No.: US 2015/0084735 A1
(43) Pub. Date: Mar. 26, 2015

(54) WEARABLE INFORMATION HANDLING DEVICE OUTPUTS

(71) Applicant: Lenovo (Singapore) Pte. Ltd., Singapore (SG)

(72) Inventors: John Miles Hunt, Raleigh, NC (US); John Weldon Nicholson, Cary, NC (US)

(73) Assignee: Lenovo (Singapore) Pte. Ltd., Singapore (SG)

(21) Appl. No.: 14/036,200

(22) Filed: Sep. 25, 2013

(51) Int. Cl. G07C 9/00

(52) U.S. Cl. CPC G07C 9/00126
USPC 340/5.6

(57) ABSTRACT

An aspect provides a wearable information handling device, including: a display; a band; one or more processors operatively coupled to the display; and a memory device accessible to the one or more processors and storing code executable by the one or more processors to: after identifying information to be communicated, form an output directed to the band of the wearable information handling device; and provide the output to the band; the output actuating one or more elements of the band. Other aspects are described and claimed.

### BACKGROUND

The popular functionalities of information handling devices (“devices”), for example smart phones, tablets, e-readers, etc., are being converted into wearable formats. An example of such a wearable information handling device is a smart watch such as the Samsung GALAXY GEAR smart watch. GALAXY GEAR is a registered trademark of Samsung Electronics Co., Ltd. in the United States and/or other countries. Other examples of wearable information handling devices include bracelets, sleeves, gloves, and like articles that, while wearable by a user, provide electronic or computing functionality similar to smart phones and other mobile computing devices.

### BRIEF SUMMARY

In summary, one aspect provides a wearable information handling device, comprising: a display; a band; one or more processors operatively coupled to the display; and a memory device accessible to the one or more processors and storing code executable by the one or more processors to: after identifying information to be communicated, form an output directed to the band of the wearable information handling device; and provide the output to the band; the output actuating one or more elements of the band.

Another aspect provides a method, comprising: identifying information to be communicated; after identifying information to be communicated, forming an output directed to a band of a wearable information handling device; and providing the output to the band; the output actuating one or more elements of the band.

A further aspect provides a wearable information handling device, comprising: a band; one or more processors; and a memory device accessible to the one or more processors and storing code executable by the one or more processors to: after identifying information to be communicated, form an output directed to the band of the wearable information handling device; and provide the output to the band; the output actuating one or more elements of the band.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates an example wearable information handling device.

FIG. 3 illustrates an example method of providing output(s) with a wearable information handling device.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Wearable information handling devices such as smart watches are an upcoming form-factor in mobile computing. With necessarily smaller screens, smart watches need more output methods if they are to fulfill their potential as always-on companion devices.

A primary output device of conventional wearable information handling devices (also referred to herein as “devices” or “information handling devices”), e.g., a smart watch, is a screen of varying capability. Since these devices are small, battery space is at a premium and power consumption is a concern. A way to alleviate the power concerns encountered by such devices is by reducing the capability of the screen, e.g., by moving to an e-ink or similar solution instead of using other screen technologies (e.g., LCD or the like). Smart watches also typically have vibrating motors (e.g., actuators) to alert the user, as well as speakers. Both of these output methods are bandwidth-limited, as the vibrating motor cannot easily convey complex information and the speaker may not be appropriate for all situations.

Accordingly, an embodiment provides a wearable information handling device such as a smart watch with a band portion having output communication capabilities. In an embodiment, the band portion includes elements that have the ability to squeeze the user's wrist. Thus, an embodiment includes band element(s) as another method of output.

The illustrated example embodiments will be best understood by reference to the figures. The following description is intended only by way of example, and simply illustrates certain example embodiments.

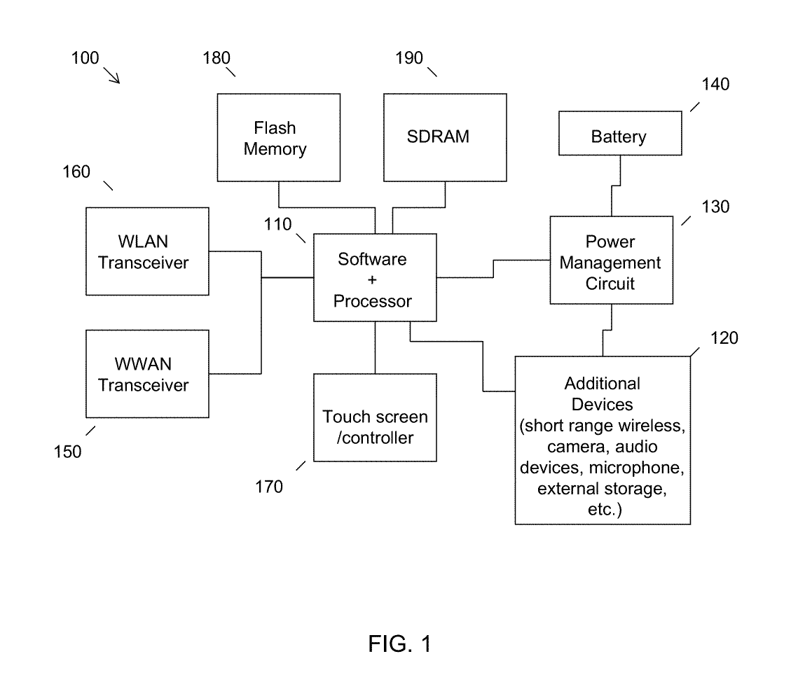

Referring to FIG. 1, while various other circuits, circuitry or components may be utilized in information handling devices, with regard to a wearable information handling device's circuitry, for example a smart watch or bracelet, an example illustrated in FIG. 1 includes a system on a chip design 100 found for example in tablet or other small, mobile computing platforms. Software and processor(s) are combined in a single chip 110. Internal busses and the like depend on different vendors, but essentially all the peripheral devices (120) such as a microphone may attach to a single chip 110. The circuitry 100 combines the processor, memory control, and I/O controller hub all into a single chip 110. Also, systems 100 of this type do not typically use SATA or PCI or LPC. Common interfaces for example include SDIO and I2C.

There are power management chip(s) 130, e.g., a battery management unit, BMU, which manage power as supplied for example via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless base stations. Commonly, system 100 will include a touch screen 170 for data input and display. System 100 also typically includes various memory devices, for example flash memory 180 and SDRAM 190. As is apparent from the description herein, embodiments may include other features or only some of the features of the example illustrated in FIG. 1.

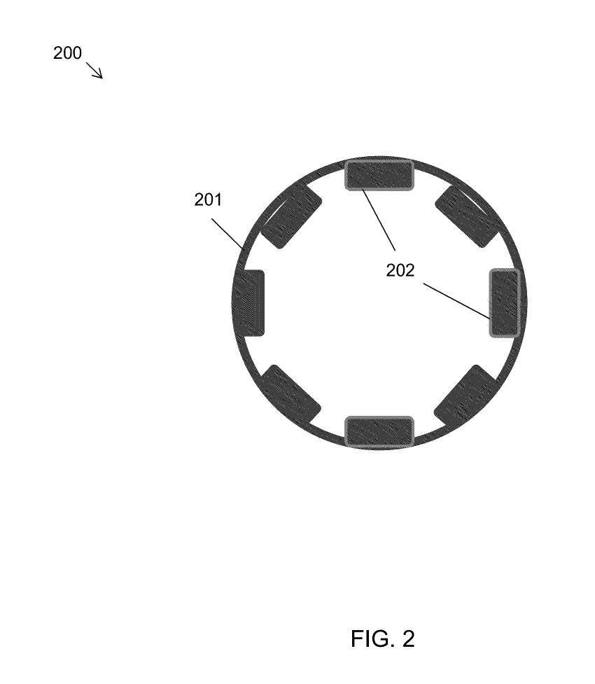

Information handling device circuitry and components, as for example outlined in FIG. 1, may be included in a wearable form factor such as a smart watch. An example is illustrated in FIG. 2. In the illustration of FIG. 2, the system or device 200 includes a band portion and one or more elements 202 in or about (e.g., attached to) the band portion. Other components, e.g., processor, touch screen display, standard display, etc., may be included but are omitted from FIG. 2 for ease of illustration.

In one embodiment, a band 201 squeezes at a single point, e.g., using one of the elements 202, to communicate (e.g., indicate a notification). Optionally, in concert with other low-bandwidth output channels, e.g., audio and/or haptic actuator(s), a more dense output message can be created without requiring the user to look at a screen or invoking a speaker with some form of natural language output directed to the user. The band 201 may squeeze at variable degrees, e.g., harder or pulse faster/repeatedly, as a form of coded communication. For example, if the band element(s) 201 were communicating output in combination with a navigation system, as the user closes in on a navigation destination, harder and/or more frequent squeezing of the band 201 via element(s) 202 may take place to catch the user's attention and alert him/her of the approaching destination.

Additionally or in the alternative, an embodiment squeezes the band 201 in different segments, as for example actuating elements 202 that are separated spatially.

This, alone or in combination with the timing of element 202 actuation, may again be used to provide a more rich output than has previously been achievable using such low-bandwidth output channels.

For example, this allows a form of crude numerical or other pattern output. For instance, the user may verbally ask “when is my next meeting?” and the watch responds with output in the form of squeezing three of its segments 202, e.g., via actuation of elements 202, to indicate that the meeting is at 3 o'clock. If the number individual pulses are hard to pick out, e.g., in the case of using only one element 202, the outputs may be differentiated, e.g., spatially and/or in time. For example, an embodiment may actuate elements in an offset fashion such that element actuation is slightly offset in time to make the outputs more easily perceivable/distinguishable.

In an embodiment, given the desired level of communication, a smart watch or other wearable device may be formed and communicate acceptably with a user without utilizing a screen (e.g., a screen-less smart watch). For example, according to an embodiment, a smart watch may take inputs (e.g., commands) verbally or by some other input modality (e.g., via hand action such as touch or gesture input) and respond with band portion actuation, alone or in combination with one or more other output channels, e.g., buzzing/haptics, audio, etc.

The squeezing of the band 201 may take place by reducing the size of the band (e.g., reducing its internal circumference) such that it squeezes a user wearing the band. The squeezing of the band 201 may take a variety of forms. For example, the squeezing of the band 201 may be implemented by swelling or enlarging the element(s) 202. The swelling in the band 201 may be provided mechanically, thermally or chemically. For example, a thermally swelled element may be provided by vaporizing some material with electrical current such that a phase change (e.g., liquid to gas) occurs and inflates a flexible/inflatable element 202. Additionally or in the alternative, a mechanically swelled element may be implemented using a flapper or displaceable element(s) that is/are erected, e.g., via a circular gear traversing the span of the band. Small actuators may be implemented to select which flapper(s) or displaceable element(s) that the gear acts on. One or more elements of the band may be actuated to change the overall size of the band in alternative or additional ways. For example, a band may include or consist of a material such as muscle wire, e.g., Nitinol or nickel/titanium, where the material undergoes a reversible or controllable conformational change responsive to an event, e.g., provisioning of electrical stimulant.

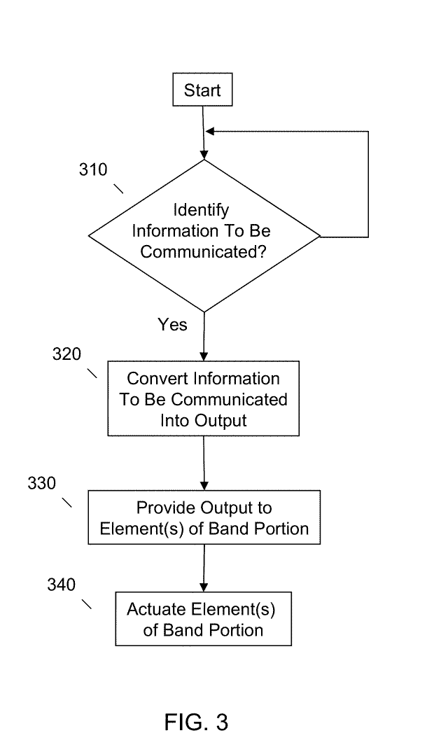

Referring to FIG. 3, an example method of providing output(s) with a wearable information handling device is illustrated. In an example use context, a wearable information handling device, e.g., a smart watch 200 such as outlined in the example of FIG. 2, may monitor for information that is to be communicated to the user. Examples of information that may be/is to be communicated to the user include a notification of an incoming message (e.g., email, text, etc.), a response to an input of the user (e.g., response to a verbal query by the user, etc.) or the like. If information is identified that is to be communicated to the user at 310, e.g., an answer to a query, a message notification, etc., an embodiment may convert the information into an output at 320. The output may include a plurality of outputs.

For example, an embodiment may identify an answer to a query at 310 as information to be communicated to the user. Thus, if a user queries “what time is my next meeting?”, an embodiment may identify information to be communicated to the user at 310 as information indicating that the next meeting is at 3:00 p.m. (e.g., via consulting a calendar application). Therefore, an embodiment may convert this information into a format suitable for use as output at 320. In one example, the information may be converted to output by translating or converting the information into command(s) to elements 202 of the band 201, e.g., actuating the appropriate elements 202.

The output may then be provided to the element(s) of the band portion at 330. In the example given herein, this may comprise actuating band element(s) (e.g., mechanically, thermally, etc.) to communicate that the next meeting of the user is at 3:00 p.m. This may take a variety of forms, as described herein. For example, the outputs may actuate the elements of the band portion at 340 simultaneously (or nearly so), at different times (e.g., spaced in time), or a combination of the foregoing. Thus, the device may use a squeezing of the band, which may take a variety of forms including but not necessarily limited to swelling of element(s) of the band portion, to provide an additional output channel or modality for a wearable device.

This permits the wearable device to leverage an additional output mechanism that may be used alone or in combination with other output mechanisms in order to communicate with the user. As described herein, the permits new modes of output to be realized and results in reducing the power necessary to communicate effectively with the wearer of the device.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A wearable information handling device, comprising:
a display;
a band;
one or more processors operatively coupled to the display; and
a memory device accessible to the one or more processors and storing code executable by the one or more processors to:
after identifying information to be communicated, form an output directed to the band of the wearable information handling device; and
provide the output to the band;
the output actuating one or more elements of the band.

2. The wearable information handling device of claim 1, wherein the one or more elements are actuated to change the overall size of the band.

3. The wearable information handling device of claim 1, wherein the one or more elements are mechanically actuated.

4. The wearable information handling device of claim 2, wherein the one or more elements are swelled.

5. The wearable information handling device of claim 1, wherein the code is further executable by the one or more processors to receive one or more user inputs;
wherein the information to be communicated is identified using the one or more user inputs.

6. The wearable information handling device of claim 5, wherein the one or more user inputs are selected from the group of user inputs consisting of audio input, touch input, and gesture input.

7. The wearable information handling device of claim 1, wherein to form an output comprises processing the information to be communicated into a coded output directed to the one or more elements of the band.

8. The wearable information handling device of claim 7, wherein the coded output comprises output provided to a plurality of elements of the band portion.

9. The wearable information handling device of claim 8, wherein the coded output provided to a plurality of elements of the band portion actuate at different times according to a predetermined code.

10. The wearable information handling device of claim 1, wherein the one or more elements undergo a conformational change responsive to output.

11. A method, comprising:
identifying information to be communicated;
after identifying information to be communicated, forming an output directed to a band of a wearable information handling device; and
providing the output to the band;
the output actuating one or more elements of the band.

12. The method of claim 11, wherein the one or more elements are actuated to change the overall size of the band.

13. The method of claim 11, wherein the one or more elements are mechanically actuated.

14. The method of claim 12, wherein the one or more elements are swelled.

15. The method of claim 11, further comprising receiving one or more user inputs;
wherein the information to be communicated is identified using the one or more user inputs.

16. The method of claim 15, wherein the one or more user inputs are selected from the group of user inputs consisting of audio input, touch input, and gesture input.

17. The method of claim 11, wherein forming an output comprises processing the information to be communicated into a coded output directed to the one or more elements of the band.

18. The method of claim 17, wherein the coded output comprises output provided to a plurality of elements of the band portion.

19. The method of claim 18, wherein the coded output provided to a plurality of elements of the band portion actuate at different times according to a predetermined code.

20. A wearable information handling device, comprising:
a band;
one or more processors; and
a memory device accessible to the one or more processors and storing code executable by the one or more processors to:
after identifying information to be communicated, form an output directed to the band of the wearable information handling device; and
provide the output to the band;
the output actuating one or more elements of the band.
